(19) United States
(12) Patent Application Publication
(10) Pub. No.: US 2018/0341154 A1
(43) Pub. Date: Nov. 29, 2018

(54) LIGHT IRRADIATION DEVICE, LIQUID CRYSTAL ALIGNMENT METHOD, AND APPARATUS

(71) Applicant: SHENZHEN CHINA STAR OPTOELECTRONICS TECHNOLOGY CO., LTD., Shenzhen, Guangdong (CN)

(72) Inventor: Rentang Zhao, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 15/329,361

(22) PCT Filed: Jan. 16, 2017
(86) PCT No.: PCT/CN2017/071238

§ 371 Date: Oct. 3, 2017

(30) Foreign Application Priority Data
Dec. 26, 2016 (CN) 201611217557.6

(51) Int. Cl. G02F 1/1337; G02F 1/13; G21K 5/02

(52) U.S. Cl. CPC G02F 1/133788; G02F 1/137; G21K 5/02; G02F 1/1303

(57) ABSTRACT

Disclosed are a light irradiation device, a liquid crystal alignment method, and an apparatus. The light irradiation device includes one or a plurality of light boxes, each of which is provided therein with a plurality of light-emitting members and is configured to emit light from inside to outside thereof through the light-emitting members. Light-emitting surfaces of the light boxes are in a same plane. The light-emitting members are light emitting diodes which emit ultraviolet light used for liquid crystal alignment. Therefore, an auxiliary device is no longer needed to block out unnecessary light, thereby reducing costs. In addition, the ultraviolet light will not damage a liquid crystal structure and thus quality of a liquid crystal panel is improved. By using light-emitting diodes, energy consumption can be reduced and frequent replacement of lamp tubes can be avoided, thereby improving productivity.

### CROSS-REFERENCE TO RELATED APPLICATIONS

This application claims the priority of Chinese patent application CN 201611217557.6, entitled “Light Irradiation Device, Liquid Crystal Alignment Method, and Apparatus” and filed on Dec. 26, 2016, the entirety of which is incorporated herein by reference.

### FIELD OF THE INVENTION

The present disclosure relates to the technical field of liquid crystal display, and in particular, to a light irradiation device, a liquid crystal alignment method, and an apparatus.

### BACKGROUND OF THE INVENTION

In a liquid crystal display device, liquid crystals cover an entire panel of the display device in the form of a thin layer. In this case, liquid crystal molecules need to be neatly arranged in a certain direction (called “alignment”). When light falls on the display device, it depends on alignment of the liquid crystal molecules whether the light is transmitted or the light is obscured. Therefore, it is necessary for all liquid crystal molecules to be arranged in a same direction constantly. At present, commonly used nematic liquid crystals are rod-like molecules. These rod-like molecules per se can be naturally arranged in a certain direction within a certain range of angles, but if not controlled, this arrangement is often of a certain degree of dispersion. In order to meet the requirements for use of the display device, liquid crystal molecules need to be arranged in an orderly manner. However, the natural force among the molecules merely is not enough, and therefore artificial control is necessary.

At present, a widely used liquid crystal alignment technology is PS-VA (Polymer Stabilized Vertical Alignment). In a PS-VA cell process, liquid crystals contain reactive monomers, and there is a liquid crystal alignment process. The reactive monomers in the liquid crystals are caused to react by irradiating a substrate with UV light so that the liquid crystal forms a pretilt angle, which is called ultraviolet light alignment.

In an ultraviolet light alignment process, an ultraviolet light source is needed. Main light-emitting members of ultraviolet light sources used in the prior art are metal halide lamps or fluorescent lamps, which have low light emitting efficiency and short service life, generally several thousand hours. Moreover, these light-emitting members are easily broken and contain harmful substances (such as mercury). They emit light with a broad range of wavelengths, including useless light and even light with wavelengths harmful to production. FIG. 1 shows wavelengths of light emitted by a light-emitting member in the prior art. It can be seen from FIG. 1 that the light has a broad range of wavelengths. However, only effective light with a short wavelength is required in actual ultraviolet light alignment. The light with too short wavelengths, as shown in Frame 2 in FIG. 1, may cause implosion of the reactive monomer and damage a liquid crystal structure. The light with too long wavelengths, as shown in Frame 3, may cause heat. Therefore, an auxiliary device is needed in the prior art to block out unnecessary light and cooling equipment is needed to cool the light-emitting members. As a result, unnecessary costs are incurred.

Furthermore, a light-emitting member of the prior art is generally provided in the form of a lamp tube, and requires a high voltage to excite light emission, which is energy intensive. Moreover, when a machine base is too large, in order to match the size of the machine base, the lamp tube needs to be made so long that a drive voltage is required to be higher. Thus, energy consumption is further increased. Besides, illumination uniformity of a long lamp tube is not high.

### SUMMARY OF THE INVENTION

In order to solve the problem in the prior art that a liquid crystal alignment light source is low in efficiency, high in cost and high in energy consumption, the present disclosure provides a light irradiation device, and provides a liquid crystal alignment method and an apparatus at the same time.

The light irradiation device provided by the present disclosure comprises one or a plurality of light boxes each provided with a plurality of light-emitting members and configured to emit light from inside to outside thereof through the light-emitting members. Light-emitting surfaces of the light boxes are in a same plane.

The light irradiation device is composed of arranged light boxes, and therefore, in the liquid crystal alignment process, the number of light boxes can be selected according to a size of a liquid crystal cell so that energy consumption and costs can be reduced.

As a further improvement to the present disclosure, the light is ultraviolet light. The light irradiation device emitting ultraviolet light can directly provide ultraviolet light used for liquid crystal alignment, and no auxiliary device is needed to block out unnecessary light. Thus, costs can be further reduced. In addition, the ultraviolet light does not damage a liquid crystal structure and thus a quality of a LCD panel can be improved.

As a further improvement to the present disclosure, the light-emitting members are light emitting diodes (LEDs). A wavelength range of a light-emitting diode is relatively concentrated. Through selection of semiconductor materials and change of material doping methods, the ultraviolet light required for liquid crystal alignment can be obtained directly. Meanwhile, a LED light source contains no mercury and other harmful substances, and has high luminous efficiency, low energy consumption, and a service life up to tens of thousands to hundreds of thousands of hours. Thus, frequent replacement of light boxes can be avoided, thereby reducing operating costs and improving productivity. At the same time, because a LED has a small size, they can be arranged in the light boxes in an intended manner to further improve the production flexibility.

In particular, when a wavelength of ultraviolet light is in a range of from 280 nm to 400 nm, liquid crystal alignment can be fully realized. Also, because light with other wavelengths is not present, a liquid crystal structure would not be damaged and no heat would be caused. As a result, not only quality of a product is improved, but also an auxiliary device is no longer needed for cooling treatment, thereby further reducing production costs.

When the light intensity of the light emitting diodes is adjusted by adjusting a voltage at both ends of each light emitting diode, in order to match the manufacture process, the light intensity of the light irradiation device can be controlled according to the needs of the manufacture process, further reducing the energy consumption and improving the product quality.

As a further improvement to the light irradiation device, the light emitting surfaces of the light boxes are circular or polygonal in shape. Light boxes with such shapes are easy to manufacture. When the plurality of the light boxes are arranged in a matrix, to meet a requirement of a regular square-shaped liquid crystal panel, the number of rows and columns of the light boxes can be set according to a size of the liquid crystal panel. When the plurality of the light boxes are arranged concentrically, to meet a requirement of a circle-shaped liquid crystal panel, the number and spacing of concentric circles can be set according to a diameter of the liquid crystal panel. Thus, excess light boxes are voided so as to realize energy conservation.

The present disclosure further provides a liquid crystal alignment method, characterized in that a substrate is irradiated with a light irradiation device provided by the present disclosure so that a liquid crystal forms a pretilt angle to complete the liquid crystal alignment.

The present disclosure further provides an apparatus, characterized in that the apparatus comprises a machine base and a light irradiation device from bottom to top; a liquid crystal cell is placed on the machine base; and light emitted from the light irradiation device irradiates the liquid crystal cell to complete the liquid crystal alignment.

In summary, the light irradiation device according to the present disclosure can directly provide ultraviolet light used for liquid crystal alignment in the liquid crystal alignment process, and an auxiliary device is no longer needed to block out unnecessary light, so that costs can be further reduced. In addition, the ultraviolet light may not cause damage to a liquid crystal structure, thus improving quality of a liquid crystal panel. Light-emitting diodes are used for emitting ultraviolet light so as to further reduce energy consumption and to avoid frequent replacement of lamp tubes, thereby improving productivity.

### BRIEF DESCRIPTION OF THE DRAWINGS

The present disclosure will be described in a more detailed way below based on embodiments and with reference to the accompanying drawings, in which:

FIG. 1 schematically shows a wavelength range of light emitted from a light-emitting member in the prior art;

FIG. 2 schematically shows a light-emitting surface of a light irradiation device when light boxes are arranged in a matrix;

FIG. 3 schematically shows the light-emitting surface of the light irradiation device when light boxes are arranged concentrically;

FIG. 4 schematically shows an internal structure of a light box;

FIG. 5 schematically shows a wavelength range of light emitted from the light irradiation device of the present disclosure;

FIG. 6 schematically shows a structure of an apparatus for liquid crystal alignment;

FIG. 7a schematically shows a structure of an irradiation source composed of light irradiation devices in the present disclosure; and

FIG. 7b schematically shows a structure of an irradiation source composed of lamp tubes in the prior art.

In the accompanying drawings, same components use same reference signs. The accompanying drawings are not drawn according to actual proportions.

### DETAILED DESCRIPTION OF THE EMBODIMENTS

The present disclosure will be explained in details below with reference to the embodiments. Terms such as “upper”, “lower”, “left”, and “right” below are referred to with respect to positions in the figures, and should not be construed as limiting the present disclosure.

### Embodiment 1

FIG. 2 schematically shows a light-emitting surface of a light irradiation device 10 according to the present disclosure. A lamp body 12 of the light irradiation device 10 has a quadrangular shape. The lamp body 12 comprises a plurality of light boxes 11, each of which is provided with a plurality of light-emitting members. Each of the light boxes 11 emits light from the inside to the outside thereof through the plurality of internal light-emitting members, and light emitting surfaces the light boxes 11 are in a same plane. The light emitting surface of the light box 11 has a quadrangular shape, and of course, the light emitting surface of the light box 11 may be in circular or other shapes. The shape of the light emitting surface of the light box 11 may be set according to actual needs.

According to the present embodiment, the plurality of light boxes 11 are arranged in matrix. As shown in FIG. 2, the light boxes 11 are arranged in three rows and nine columns. The specific number of rows and columns can be determined according to an actual size of a liquid crystal panel. Thus, excess light boxes can be avoided so as to reduce energy consumption and costs.

### Embodiment 2

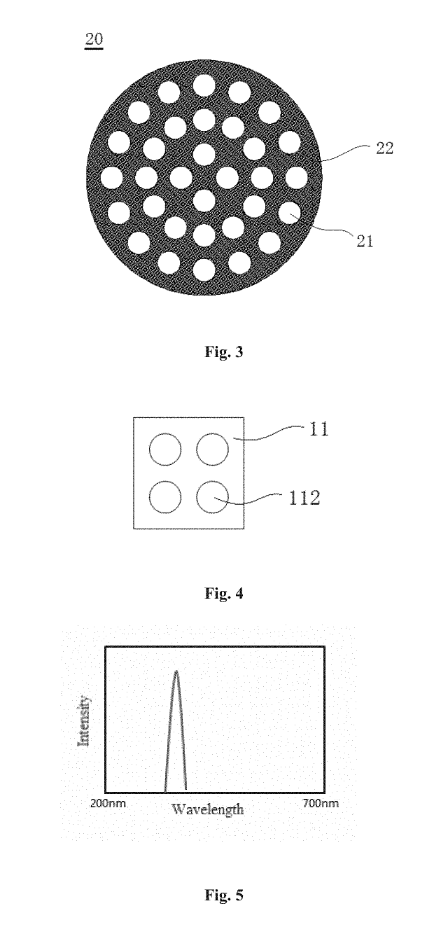

FIG. 3 schematically shows a light-emitting surface of a light irradiation device 20 according to the present disclosure. A lamp body 22 of the light irradiation device 20 has a circular shape. The lamp body 22 comprises a plurality of light boxes 21, each of which is provided with a plurality of light-emitting members. Each of the light boxes 21 emits light from the inside to the outside thereof through the plurality of internal light-emitting members, and light emitting surfaces of the light boxes 21 are in a same plane. The light emitting surface of the light box 21 has a circular shape, and of course, the light emitting surface of the light box 21 may be in other shapes. The shape of the light emitting surface of the light box 21 may be set according to actual needs.

According to the present embodiment, the plurality of light boxes 11 are arranged in a circular manner concentrically with an outer circumference of the lamp body 22. As shown in FIG. 3, the light boxes 21 are arranged in three concentric circles, and such an arrangement is particularly suitable for a circular-shaped liquid crystal panel. The specific number of concentric circles and light boxes on each concentric circle can be determined according to a size of an actual liquid crystal panel. Thus, excess light boxes can be avoided so as to reduce energy consumption and costs.

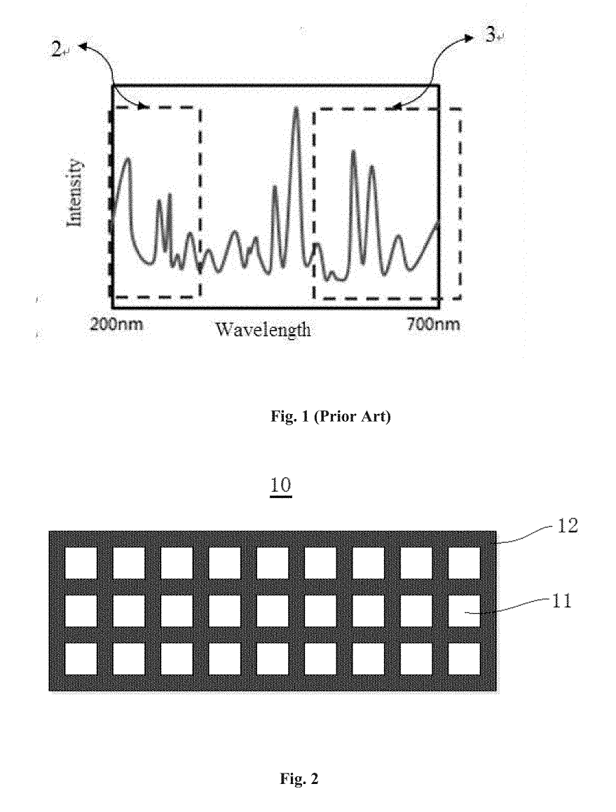

FIG. 4 schematically shows an internal structure of a light box, and it can be seen that the light box 11 is provided therein with a plurality of light-emitting members 112, and each light-emitting member 112 emits ultraviolet light under a voltage. The ultraviolet light may satisfy the demand for liquid crystal alignment. There is no longer light with other wavelengths, and therefore there is no need for an auxiliary device to block out light. Thus, production costs can be further reduced. The light-emitting member 112 is preferably a light emitting diode. The light emitting diode has characteristics such as low power consumption and small size, which makes the structure of the light box 11 more flexible and reduces energy consumption. Moreover, a wavelength range of the light-emitting diode is relatively concentrated, and through the selection of semiconductor materials and the change of material doping methods, the ultraviolet light required for the liquid crystal alignment can be obtained directly. Meanwhile, a LED light source contains no mercury and other harmful substances, and has high luminous efficiency, low energy consumption, and a service life up to tens of thousands to hundreds of thousands of hours. Thus, frequent replacement of light boxes is avoided, thereby reducing operating costs and improving productivity. In particular, when the wavelength of the light emitted from the light-emitting member 112 is controlled within a range of from 280 nm to 400 nm, it can be seen from a comparison of FIG. 5 (which shows a wavelength range of light emitted from the light irradiation device of the present disclosure) and FIG. 1 that the light emitted from the light irradiation device of the present disclosure contains no light of other wavelength ranges. Therefore, a liquid crystal structure would not be damaged and no heat would be caused so that production costs can be further reduced and a quality of the product is improved.

Similarly, the light box 21 may be provided therein with more light-emitting members according to actual needs, and the light-emitting members are preferably light emitting diodes.

The light intensity of the light-emitting diodes can be adjusted by adjusting a voltage at both ends thereof to achieve the light intensity adjustment of the light irradiation device so as to meet requirements for liquid crystal alignment in different stages.

In manufacture of a liquid crystal cell, in the liquid crystal alignment process, the light irradiation device of the present disclosure can be used to irradiate a substrate with ultraviolet light, so that a liquid crystal forms a pretilt angle to complete the liquid crystal alignment.

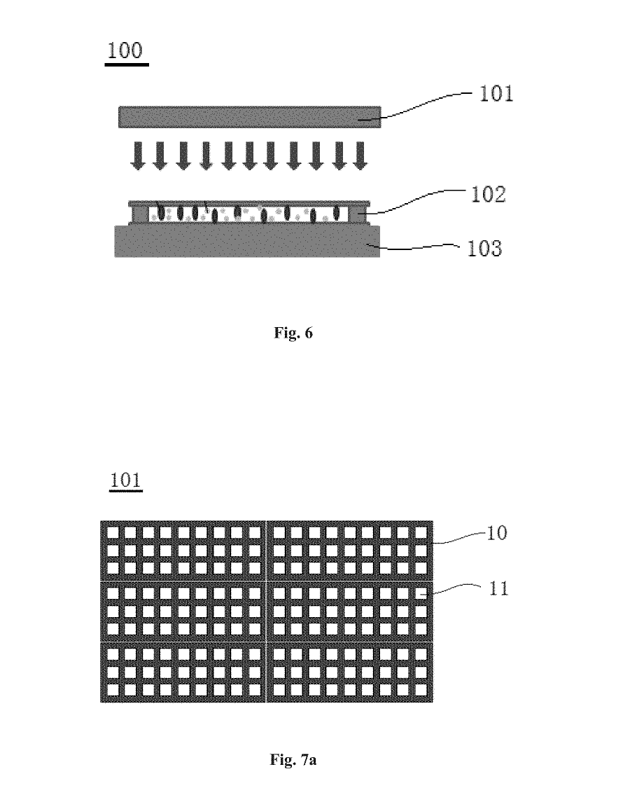

FIG. 6 schematically shows a structure of an apparatus 100 for liquid crystal alignment. An irradiation source 101 is arranged above a machine base 103. A liquid crystal cell 102 for liquid crystal alignment is placed on an upper surface of the machine base 103. The irradiation source 101 is turned on to irradiate the liquid crystal cell 102 so that a liquid crystal forms a pretilt angle to complete the liquid crystal alignment.

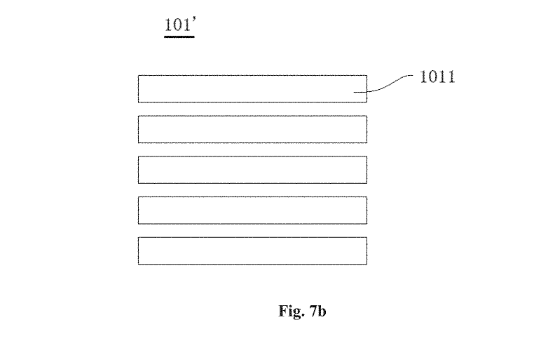

FIG. 7a shows an arrangement of an irradiation source 101 in a liquid crystal alignment apparatus 100. The irradiation source 101 comprises a plurality of light irradiation devices 10 which are arranged as required. When a size of the liquid crystal cell is changed, excess light boxes can be disassembled according to needs to realize energy conservation.

FIG. 7b schematically shows a structure in which lamp tubes 1101 are used as irradiation sources 101′ in the prior art. Since a length of each lamp tube 1011 is determined, the lamp tubes cannot be varied as desired when the liquid crystal panel changes along a length direction of the lamp tubes 1011, which results in energy consumption.

It should be noted herein that the above embodiments are described only for explaining, rather than restricting the technical solutions of the present disclosure. While the present disclosure is explained in details with reference to the preferred embodiments, it should be understood by any person skilled in the art that the technical solutions of the present disclosure may be amended or equivalently replaced without departing from the spirit and scope of the present disclosure. The protection scope of the present disclosure shall be determined by the scope as defined in the claims.

1. A light irradiation device, comprising one or a plurality of light boxes,
wherein each of the light boxes is provided therein with a plurality of light-emitting members and is configured to emit light from inside to outside thereof by means of the light-emitting members, and
wherein light-emitting surfaces of the light boxes are in a same plane.

2. The light irradiation device according to claim 1, wherein the light is ultraviolet light.

3. The light irradiation device according to claim 2, wherein the light-emitting members are light emitting diodes.

4. The light irradiation device according to claim 2, wherein a wavelength of the ultraviolet light is in a range of from 280 nm to 400 nm.

5. The light irradiation device according to claim 3, wherein a wavelength of the ultraviolet light is in a range of from 280 nm to 400 nm.

6. The light irradiation device according to claim 5, wherein light intensity of the light emitting diodes is adjusted by adjusting a voltage at both ends of each light emitting diode.

7. The light irradiation device according to claim 1, wherein the light emitting surfaces of the light boxes are circular or polygonal in shape.

8. The light irradiation device according to claim 7, wherein the plurality of the light boxes are arranged in a matrix.

9. The light irradiation device according to claim 7, wherein the plurality of the light boxes are arranged concentrically.

10. A liquid crystal alignment method, comprising irradiating a substrate with a light irradiation device to cause a liquid crystal to form a pretilt angle,
wherein the light irradiation device comprises one or more light boxes each provided therein with a plurality of light-emitting members, each of the light boxes being configured to emit light from inside to outside thereof by means of the light-emitting members,
wherein the light-emitting surfaces of the light boxes are in a same plane; and
wherein the light is ultraviolet light.

11. An apparatus, which is provided with a machine base and a light irradiation device from bottom to top, wherein a liquid crystal cell is placed on the machine base, and the liquid crystal cell is irradiated with light emitted from the light irradiation device to complete liquid crystal alignment,
wherein the light irradiation device comprises one or a plurality of light boxes each provided therein with a plurality of light-emitting members and configured to emit light from inside to outside thereof by means of the light-emitting members,
wherein light-emitting surfaces of the light boxes are in a same plane; and
wherein the light is ultraviolet light.

12. The light irradiation device according to claim 11, wherein the light-emitting members are light emitting diodes.

13. The light irradiation device according to claim 12, wherein a wavelength of the ultraviolet light is in a range of from 280 run to 400 nm.

14. The light irradiation device according to claim 5, wherein light intensity of the light emitting diodes is adjusted by adjusting a voltage at both ends of each light emitting diode.

15. The light irradiation device according to claim 11, wherein the light emitting surfaces of the light boxes are circular or polygonal in shape.

16. The light irradiation device according to claim 15, wherein the plurality of the light boxes are arranged in a matrix.

17. The light irradiation device according to claim 15, wherein the plurality of the light boxes are arranged concentrically.
